(19) United States
(12) Patent Application Publication
(10) Pub. No.: US 2012/0220419 A1
(43) Pub. Date: Aug. 30, 2012

(54) DRIVING BODY ACCELERATION DEVICE USING ELASTICITY

(76) Inventor: Nam Joon Cho, Anyang-si (KR)

(21) Appl. No.: 13/502,965

(22) PCT Filed: Oct. 7, 2010
(86) PCT No.: PCT/KR2010/006848

§ 371 Date: Apr. 19, 2012

(30) Foreign Application Priority Data
Nov. 17, 2009 (KR) 10-2009-0110833

(51) Int. Cl. F16H 3/44

(52) U.S. Cl. 475/331

(57) ABSTRACT

A driving body acceleration device using elasticity includes an input gear, a carrier connected to the input gear, planetary gears mounted to the carrier such that each of the planetary gears is rotated about a hinge shaft, a sun gear threadedly engaged with the planetary gears while being surrounded by the planetary gears, an output shaft coupled to the center of the sun gear, a cam having a cam groove, and acceleration units, each of which has one end coupled to a corresponding one of the hinge shafts and the other end coupled to the cam groove, and each of which rotates a corresponding one of the hinge shafts such that each of the planetary gears is rotated, when the revolution angle at one end of each of the acceleration units is different from that at the other end of each of the acceleration units.

### TECHNICAL FIELD

The present invention relates to a driving body acceleration device using elasticity, and, more particularly, to a driving body acceleration device using elasticity that is capable of increasing rotational speed of an output shaft using rolling elasticity without reduction of torque transmitted from a power source.

### BACKGROUND ART

Generally, an apparatus, such as a machine tool or a transmission for vehicles, varies speed and torque using a transmission so as to obtain necessary speed and torque without direct use of power transmitted from a power source.

Such a transmission may include a device using a worm and worm gear and a device using a disk friction wheel. However, a planetary gear unit is widely used as the planetary gear unit enables speed and transmission ratio to be easily changed.

In a conventional planetary gear unit, a pair of gears is threadedly engaged with each other such that both the gears are rotated about their axes while one of the gears is revolved on the axis of the other gear so as to decrease the rate of rotation and increase torque.

The conventional planetary gear unit includes an internal gear forming the external appearance of the planetary gear unit, the internal gear having a gear train formed at the inner circumference thereof, a sun gear disposed at the center of the internal gear, the sun gear having an input shaft, which is rotated by a power source, a plurality of planetary gears disposed between the sun gear and the internal gear such that the planetary gears are threadedly engaged with the sun gear and the internal gear, and a disk-shaped carrier disposed at one side of the internal gear such that shaft ends of the respective planetary gears are rotatably coupled to the carrier, the carrier having an output shaft provided at the center thereof. The internal gear is stationary, and the planetary gears are rotated and revolved upon rotation of the sun gear.

Consequently, rotational speed of the sun gear is reduced by the revolution of the planetary gears. In addition, the carrier is rotated by the revolution of the planetary gears. At this time, rotational speed of the output shaft of the carrier is less than the rotational speed of an input shaft of the sun gear. On the other hand, torque of the output shaft of the carrier is greater than the torque of the input side of the sun gear. That is, the input shaft exhibiting high speed and low torque provides low speed and high torque to the output shaft through the revolution of the planetary gears.

In the conventional planetary gear unit, however, rotational speed (RPM) is considerably decreased although the torque is increased, with the result that the use of the conventional planetary gear unit is limited in apparatuses simultaneously requiring high torque and high-speed rotation.

### DISCLOSURE OF INVENTION

### Technical Problem

Therefore, the present invention has been made in view of the above problems, and it is an object of the present invention to provide a driving body acceleration device using elasticity in which acceleration units are disposed around an output shaft, to which power is transmitted from a power source, in a radial manner so as to increase torque through rolling elasticity while maintaining high rotational speed.

### Solution to Problem

In accordance with an aspect of the present invention, the above and other objects can be accomplished by the provision of a driving body acceleration device using elasticity including an input gear to which power is transmitted from a power source, a carrier connected to the input gear such that the carrier is rotated together with the input gear, planetary gears mounted to the carrier such that each of the planetary gears is rotated about a hinge shaft, the planetary gears being revolved upon rotation of the carrier, a sun gear threadedly engaged with the planetary gears while being surrounded by the planetary gears, the sun gear being rotated about the axis thereof upon revolution of the planetary gears, an output shaft coupled to a center of the sun gear such that the output shaft is rotated together with the sun gear, a cam in which the carrier is located, the cam guiding rotation of the carrier, the cam being provided at the circumference thereof with a cam groove, and acceleration units, each of which has one end coupled to a corresponding one of the hinge shafts such that one end of each of the acceleration units is revolved upon rotation of the carrier and the other end coupled to the cam groove such that the other end of each of the acceleration units is revolved along the cam groove, and each of which rotates a corresponding one of the hinge shafts such that each of the planetary gears is rotated, when the revolution angle at one end of each of the acceleration units is different from the revolution angle at the other end of each of the acceleration units, thereby accelerating rotation of the output shaft.

The cam may include a carrier location part formed at a center thereof to guide rotation of the carrier, a lower part of which is located in the carrier location part, the cam groove may be formed at a circumference of the carrier location part in the shape of a closed loop such that one end of each of the acceleration units is located in the cam groove, and the cam groove may be provided with a movement delay protrusion, which serves to delay the movement of a driving roller of each of the acceleration units when the driving roller of each of the acceleration units passes by the movement delay protrusion, such that the revolution of one end of each of the acceleration units at which the driving roller of each of the acceleration units is disposed is delayed by the movement delay protrusion while the other end of each of the acceleration units is continuously revolved upon rotation of the carrier, with the result that the planetary gears are rotated about the respective hinge shafts.

The movement delay protrusion may include a plurality of movement delay protrusions formed at the cam groove in a radial manner.

Each of the acceleration units may include a rod provided at one end thereof with a coupling part, which is coupled to a corresponding one of the hinge shafts such that the coupling part is revolved upon rotation of the carrier, a driving roller coupled to the other end of the rod, the driving roller being located in the cam groove such that the driving roller is moved along the cam groove upon revolution of the rod, and a roller shaft having one end coupled to the other end of the rod and the other end coupled to the driving roller.

The acceleration units may be mounted on the respective hinge shafts to which the planetary gears are coupled, the acceleration units being disposed around the output shaft in a radial manner.

The driving body acceleration device may further include a ratchet bearing coupled between the outer circumference of each of the hinge shafts and the inner circumference of the coupling part of each of the rods such that each of the hinge shafts is rotated upon rotation of each of the rods on a corresponding one of the hinge shafts and such that each of the rods is idled upon return of each of the rods to the original position thereof.

### Advantageous Effects of Invention

As is apparent from the above description, the present invention has the following effects. Upon rotation of the input gear and the carrier, the planetary gears are revolved in the carrier to rotate the sun gear and the output shaft. When the driving rollers pass by the movement delay protrusions, the movement of the driving rollers is delayed by the movement delay protrusions, with the result that the rods are pulled back. Consequently, the planetary gears are rotated to further rotate the sun gear and the output shaft. That is, the planetary gears are rotated, whenever the driving rollers sequentially pass by the movement delay protrusions, to further rotate the output shaft, which is rotated together with the carrier 20. As a result, the rotational speed of the output shaft is increased. Consequently, it is possible to increase rotational speed of the output shaft using rolling elasticity without reduction of torque transmitted to the input gear.

### BRIEF DESCRIPTION OF DRAWINGS

The above and other objects, features and other advantages of the present invention will be more clearly understood from the following detailed description taken in conjunction with the accompanying drawings, in which:

FIG. 1 is a perspective view schematically illustrating a driving body acceleration device using elasticity according to an embodiment of the present invention;

FIG. 2 is an exploded perspective view schematically illustrating the driving body acceleration device of FIG. 1;

FIG. 3 is a sectional view schematically illustrating the driving body acceleration device of FIG. 1;

FIG. 4 is a plan view schematically illustrating the driving body acceleration device of FIG. 1;

FIG. 5 is a plan view schematically illustrating a state in which a carrier and acceleration units are simultaneously rotated by a predetermined angle;

FIG. 6 is a plan view schematically illustrating a state in which planetary gears are rotated about axes thereof while movement of driving rollers of the acceleration units is delayed by movement delay protrusions of a cam groove during rotation of the carrier with the result that an output shaft is further rotated than the carrier; and

FIG. 7 is an exploded perspective view schematically illustrating a driving body acceleration device using elasticity according to another embodiment of the present invention in which acceleration units are mounted in a two-stage structure.

### BEST MODE FOR CARRYING OUT THE INVENTION

Now, a preferred embodiment of the present invention will be described in detail with reference to the accompanying drawings. In the following, a detailed description of known functions and configurations incorporated herein will be omitted when it may make the subject matter of the present invention rather unclear.

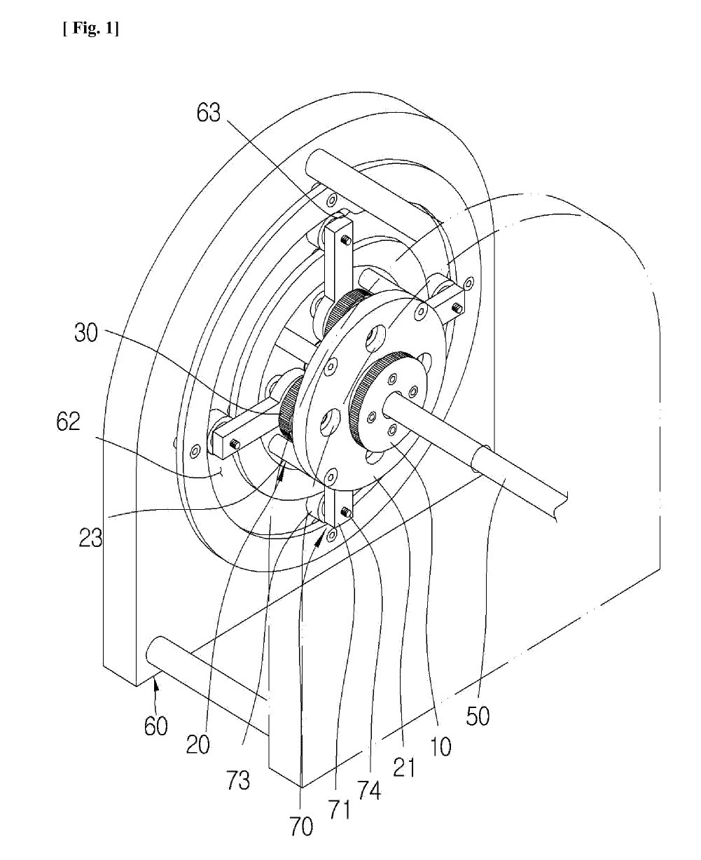

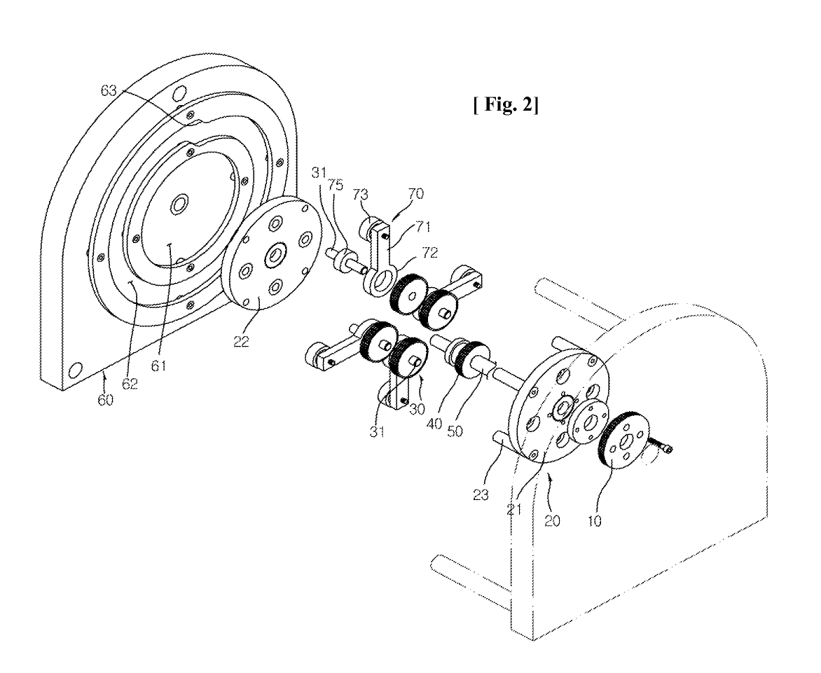

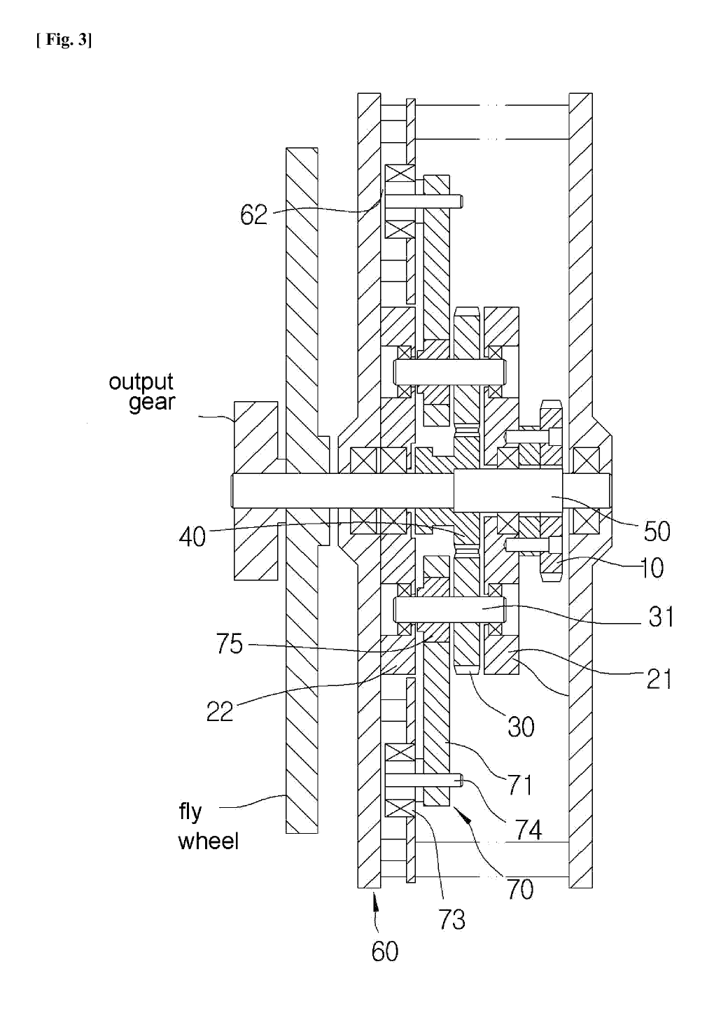

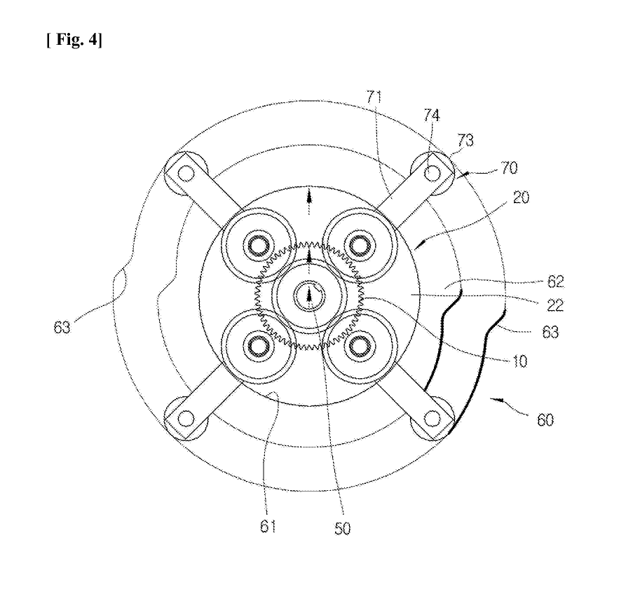

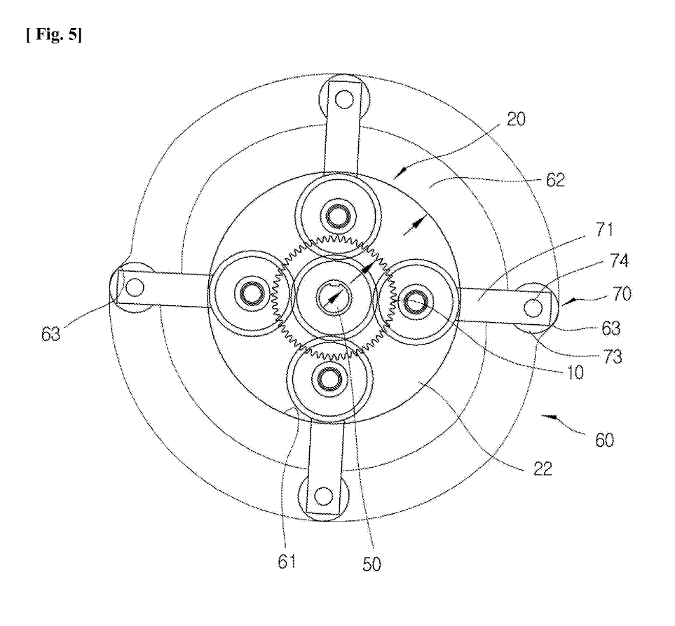

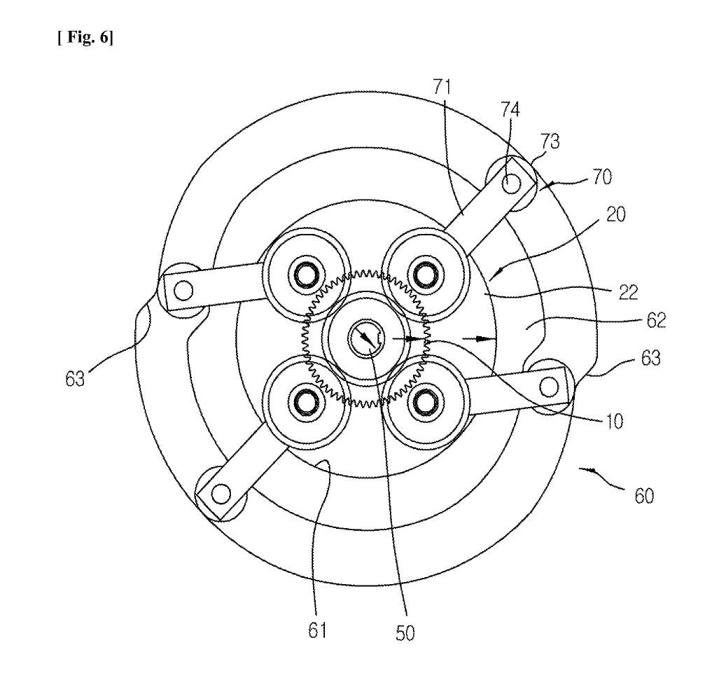

FIG. 1 is a perspective view schematically illustrating a driving body acceleration device using elasticity according to an embodiment of the present invention, FIG. 2 is an exploded perspective view schematically illustrating the driving body acceleration device of FIG. 1, and FIG. 3 is a sectional view schematically illustrating the driving body acceleration device of FIG. 1. FIG. 4 is a plan view schematically illustrating the driving body acceleration device of FIG. 1, FIG. 5 is a plan view schematically illustrating a state in which a carrier and acceleration units are simultaneously rotated by a predetermined angle, and FIG. 6 is a plan view schematically illustrating a state in which planetary gears are rotated about axes thereof while movement of driving rollers of the acceleration units is delayed by movement delay protrusions of a cam groove during rotation of the carrier with the result that an output shaft is further rotated than the carrier.

The driving body acceleration device using elasticity according to this embodiment of the present invention includes an input gear 10, a carrier 20, planetary gears 30, a sun gear 40, an output shaft 50, a cam 60, and acceleration units 70.

Power is transmitted from a power source to the input gear 10.

The carrier 20 is connected to the input gear 10 such that the carrier 20 can be rotated simultaneously with the input gear 10. The carrier 20 includes an upper carrier part 21, to the center of which the input gear 10 is fixed, a lower carrier part 22 located in a carrier location part 61 of the cam 60, which will be described later, and carrier fixing rods 23 connected between the upper carrier part 21 and the lower carrier part 22 to fixedly support the upper carrier part 21 and the lower carrier part 22. The carrier 20 is mounted such that the carrier 20 can be rotated about its axis while being located in the carrier location part 61 of the cam 60.

The planetary gears 30 are mounted to the carrier 20 such that each of the planetary gears 30 can be rotated about a hinge shaft 31. Also, the planetary gears 30 are revolved upon rotation of the carrier 20. In this embodiment, four planetary gears 30 are mounted between the upper carrier part 21 and the lower carrier part 22 in a radial manner. Each of the planetary gears 30 is fixed to the hinge shaft 31. The upper and lower ends of the hinge shaft 31 are coupled to the upper carrier part 21 and the lower carrier part 22 via bearings, respectively.

The sun gear 40 is threadedly engaged with the four planetary gears 30 at the outer circumference thereof. The sun gear 40 is rotated about its axis when the planetary gears 30 are revolved upon rotation of the carrier 20.

The output shaft 50 is coupled to the center of the sun gear 40. When the sun gear 40 is rotated about its axis by the planetary gears 30, the output shaft 50 is rotated simultaneously with the sun gear 40.

The carrier 20 is located in the cam 60. The cam 60 guides rotation of the carrier 20. A cam groove 62 is formed at the circumference of the cam 60.

The carrier location part 61 is formed at the center of the cam 60 to guide rotation of the carrier 20, the lower carrier part 22 of which is located in the carrier location part 61. The cam groove 62 is formed at the circumference of the carrier location part 61 in the shape of a closed loop such that the driving rollers 73 of the respective acceleration units 70 are located in the cam groove 62. At the cam groove 62 are formed movement delay protrusions 63, which serve to delay the movement of the driving rollers 73 of the acceleration units 70 when the driving rollers 73 of the acceleration units 70 pass by the movement delay protrusions 63, such that the revolution of one end of each of the acceleration units 70 at which each of the driving rollers 73 of the acceleration units 70 is disposed is delayed by the movement delay protrusions while the other end of each of the acceleration units 70 adjacent to each of the hinge shafts 31 is continuously revolved upon rotation of the carrier 20, with the result that the planetary gears 30 are rotated about the respective hinge shafts 31.

Each of the acceleration units 70 has one end coupled to a corresponding one of the hinge shafts 31 such that one end of each of the acceleration units 70 can be revolved upon rotation of the carrier 20 and the other end coupled to the cam groove 62 such that the other end of each of the acceleration units 70 can be moved along the cam groove 62. When the revolution angle at one end of each of the acceleration units 70 is different from the revolution angle at the other end of each of the acceleration units 70, each of the acceleration units 70 rotates a corresponding one of the hinge shafts 31 such that each of the planetary gears 30 is rotated about a corresponding one of the hinge shafts 31, thereby accelerating rotation of the output shaft 50.

Each of the acceleration units 70 includes a rod 71, a driving roller 73, and a roller shaft 74.

The rod 71 is provided at one end thereof with a coupling part 72, which is coupled to a corresponding one of the hinge shafts 31 such that the coupling part 72 can be revolved upon rotation of the carrier 20.

The driving roller 73 is coupled to the other end of the rod 71. Also, the driving roller 73 is located in the cam groove 62 such that the driving roller 73 can be moved along the cam groove 62 upon revolution of the rod 71.

The roller shaft 74 has one end coupled to the other end of the rod 71 and the other end coupled to the driving roller 73.

The acceleration units 70 are mounted on the respective hinge shafts 31, to which the planetary gears 30 are coupled. In this embodiment, four acceleration units 70 are mounted around the output shaft 50 in a radial manner.

Meanwhile, a ratchet bearing 75 is coupled between the outer circumference of each of the hinge shafts 31 and the inner circumference of the coupling part 72 of each of the rods 71 such that each of the hinge shafts 31 can be rotated upon rotation of each of the rods 71 on a corresponding one of the hinge shafts 31 and such that each of the rods 71 can be idled upon return of each of the rods 71 to the original position thereof.

When the movement of the driving rollers 73 is delayed by the movement delay protrusions 63, with the result that the rods 71 are pulled back, the ratchet bearings 75 are rotated together with the respective hinge shafts 31 by an angle at which the rods 71 are pulled back. Subsequently, the driving rollers 73 pass by the movement delay protrusions 63 and then move along the cam groove 62, with the result that the rods 71 return to the original positions thereof. At this time, the rods 71 are idled. Consequently, when the rods 71 are pulled back, the hinge shafts 31 are rotated. On the other hand, when the rods 71 return to the original positions thereof, the hinge shafts 31 are not rotated.

Hereinafter, the operation of the driving body acceleration device using elasticity according to this embodiment of the present invention will be described in detail.

First, rotational power is transmitted from an engine to the input gear 10. At this time, the number of teeth of an electromotive gear (not shown), which transmits the power from the engine to the input gear 10, may be equal to or less than the number of teeth of the input gear 10.

When the number of teeth of the electromotive gear is equal to the number of teeth of the input gear 10, the power is transmitted to the input gear 10 without change of torque or rotational speed. When the number of teeth of the electromotive gear is less than the number of teeth of the input gear 10, on the other hand, the rotational speed of the input gear 10 is reduced, with the result that the rotational speed of the output shaft 50 is reduced; however, the torque of the output shaft 50 is increased in proportion to the reduced rotational speed of the output shaft 50.

When the rotational power is transmitted from the engine to the input gear 10, the number of teeth of which is equal to or greater than the number of teeth of the electromotive gear, the input gear 10 and the carrier 20 fixed to the input gear 10 are rotated in the carrier location part 61. When the carrier 20, which includes the upper carrier part 21 and the lower carrier part 22, is rotated by the input gear 10, the planetary gears 30, which are mounted in the carrier 20 in a radial manner, are revolved around the output shaft 50. Upon revolution of the planetary gears 30, the sun gear 40, which is threadedly engaged with the planetary gears 30, is rotated about its axis, with the result that the output shaft 50, which is fixed to the sun gear 40, is rotated.

The output shaft 50 is rotated while rotational speed and torque of the output shaft 50 are not changed or while rotational speed of the output shaft 50 is reduced and torque of the output shaft 50 is increased depending upon the number of teeth of the input gear 10.

The acceleration units 70 according to this embodiment of the present invention serve to increase rotational speed of the output shaft 50 which is rotated at uniform speed or at reduced speed, which will be described hereinafter in detail.

When the carrier 20 is rotated by the input gear 10 in a state as shown in FIG. 4, the planetary gears 30, which are fixed to the carrier 20 via the respective hinge shaft 31, are revolved. The ratchet bearings 75 are fixed to the respective hinge shafts 31, and the coupling parts 72 of the rods 71 are coupled to the respective ratchet bearings 75. When the hinge shafts 31 are revolved together with the respective planetary gears 30, therefore, the rods 71 are also revolved together with the respective hinge shafts 31.

When the rods 71 of the respective acceleration units 70 are revolved, the driving rollers 73 of the respective acceleration units 70are moved along the cam groove 62 of the cam 60. Upon rotation of the input gear 10, therefore, the input gear 10, the carrier 20, and the output shaft 50 are rotated by the same angle as indicated by arrows shown in FIG. 5.

As the input gear 10 is continuously rotated, the driving rollers 73 are moved along the cam groove 62, and are then caught by the movement delay protrusions 63. As the input gear 10 is continuously rotated in this state, the movement of the driving rollers 73 caught by the movement delay protrusions 63 is delayed while the planetary gears 30 are revolved around the output shaft 50.

That is, as shown in FIG. 6, the movement of the driving rollers 73 caught by the movement delay protrusions 63 is temporarily delayed while the coupling parts 72 of the respective rods 71 are revolved together with the planetary gears 30, with the result that the rods 71 are pulled back.

When the rods 71 are pulled back, the ratchet bearings 75 coupled to the coupling parts of the respective rods 71 are rotated, and the hinge shafts 31 coupled to the respective ratchet bearings 75 are further rotated. As a result, the planetary gears 30 coupled to the respective hinge shafts 31 are rotated.

That is, the planetary gears 30 coupled to the rods 71 are rotated about the respective hinge shafts 31 in direct proportion to the amount by which the rods 71 are pulled back, and the sun gear 40 is further rotated in direct proportion to the amount by which the planetary gears 30 are rotated, with the result that the output shaft 50 is accelerated.

In summary, the output shaft 50 is rotated at the same speed as the carrier 20, and, when movement of the driving rollers 73 is delayed by the movement delay protrusions 63 and, as a result, the rods 71 are pulled back, the output shaft 50 is further rotated by an angle at which the rods 71 are pulled back.

In this embodiment, the four driving rollers 73 are sequentially pulled back as the respective driving rollers 73 sequentially pass by the movement delay protrusions 63, with the result that the output shaft 50 is accelerated.

Like a top is whipped while the top is spun so as to increase speed of the top such that the top can be spun at a predetermined speed or more, the planetary gears 30 are sequentially rotated, whenever the four rods 71 are sequentially pulled back, to further rotate the sun gear 40 and the output shaft 50. Consequently, the output shaft 50, which is rotated together with the carrier 20, is further rotated than the carrier 20, with the result that, the output shaft 50 is accelerated.

The driving body acceleration device using elasticity according to this embodiment of the present invention has the following effects.

Upon rotation of the input gear 10 and the carrier 20, the planetary gears 30 are revolved within the carrier 20 to rotate the sun gear 40 and the output shaft 50. When the driving rollers 73 pass by the movement delay protrusions 63, the movement of the driving rollers 73 is delayed by the movement delay protrusions 63, with the result that the rods 71 are pulled back. As a result, the planetary gears 30 are rotated to further rotate the sun gear 40 and the output shaft 50.

That is, the planetary gears 30 are rotated, whenever the driving rollers 73 sequentially pass by the movement delay protrusions 63, to further rotate the output shaft 50, which is rotated together with the carrier 20. As a result, the rotational speed of the output shaft 50 is increased. Consequently, it is possible to increase rotational speed of the output shaft 50 using rolling elasticity without reduction of torque transmitted to the input gear 10.

Therefore, the driving body acceleration device according to this embodiment of the present invention has the effect of providing large torque without change of high rotational speed which is initially input. The driving body acceleration device according to this embodiment of the present invention is widely applicable to large-sized deceleration apparatuses, engines for electric trains, next-generation electric vehicles, and general vehicles, and the like.

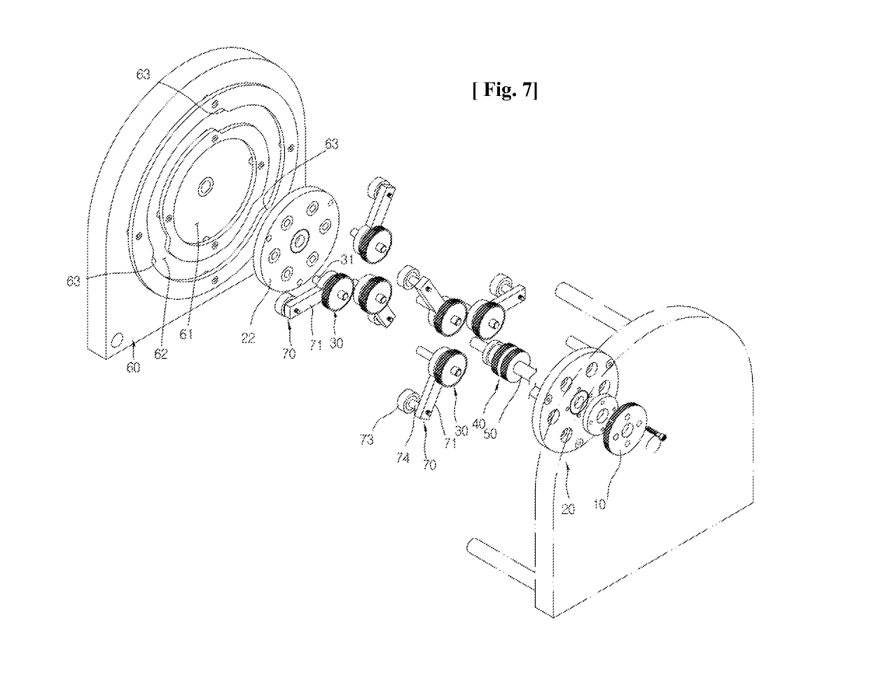

FIG. 7 is an exploded perspective view schematically illustrating a driving body acceleration device using elasticity according to another embodiment of the present invention. In the driving body acceleration device according to this embodiment, three movement delay protrusions 63 are formed at a cam groove 62 of a cam 60 in a radial manner, two sets of three acceleration units 70 are provided in a carrier 20 in a two-stage structure, and six planetary gears 30 are threadedly engaged with the circumference of a sun gear 40.

In this embodiment, the six acceleration units 70 are revolved together with the six planetary gears 30 upon rotation of the carrier 20. When three driving rollers 73 of the lower-stage acceleration units 70 come into contact with the respective movement delay protrusions 63, the driving rollers 73 of the lower-stage acceleration units 70 are delayed by the respective movement delay protrusions 63, with the result that three rods 71 of the lower-stage acceleration units 70 are simultaneously pulled back. When the rods 71 of the lower-stage acceleration units 70 are simultaneously pulled back, the three planetary gears 30 corresponding to the lower-stage acceleration units 70 are simultaneously rotated about their axes to further rotate the sun gear 40.

After the driving rollers 73 of the lower-stage acceleration units 70 pass by the respective movement delay protrusions 63, three driving rollers 73 of the upper-stage acceleration units 70 come into contact with the respective movement delay protrusions 63. The driving rollers 73 of the upper-stage acceleration units 70 are delayed by the respective movement delay protrusions 63, with the result that three rods 71 of the upper-stage acceleration units 70 are simultaneously pulled back, and therefore, an output shaft 50 is further rotated. In this way, the output shaft 50 is continuously accelerated.

That is, in this embodiment, two sets of three planetary gears 30 are provided in the carrier 20 in a two-stage structure so as to further rotate the sun gear 40, thereby increasing rotational speed of the output shaft 50 and increasing torque of the output shaft 50 in direct proportion. In this embodiment, acceleration time is shorter than in the previous embodiment shown in FIG. 2.

### Mode for the Invention

Various embodiments have been described in the best mode for carrying out the invention.

### INDUSTRIAL APPLICABILITY

According to the present invention as described above, the planetary gears are revolved in the carrier to rotate the sun gear and the output shaft upon rotation of the input gear and the carrier. When the driving rollers pass by the movement delay protrusions, the movement of the driving rollers is delayed by the movement delay protrusions, with the result that the rods are pulled back. As a result, the planetary gears are rotated to further rotate the sun gear and the output shaft. That is, the planetary gears are rotated, whenever the driving rollers sequentially pass by the movement delay protrusions, to further rotate the output shaft, which is rotated together with the carrier. As a result, the rotational speed of the output shaft is increased. Consequently, it is possible to increase rotational speed of the output shaft using rolling elasticity without reduction of torque transmitted to the input gear.

Therefore, the present invention has industrial applicability.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A driving body acceleration device using elasticity comprising: an input gear to which power is transmitted from a power source; a carrier connected to the input gear such that the carrier is rotated together with the input gear; planetary gears mounted to the carrier such that each of the planetary gears is rotated about a hinge shaft, the planetary gears being revolved upon rotation of the carrier; a sun gear threadedly engaged with the planetary gears while being surrounded by the planetary gears, the sun gear being rotated about an axis thereof upon revolution of the planetary gears; an output shaft coupled to a center of the sun gear such that the output shaft is rotated together with the sun gear; a cam in which the carrier is located, the cam guiding rotation of the carrier, the cam being provided at a circumference thereof with a cam groove; and acceleration units, each of which has one end coupled to a corresponding one of the hinge shafts such that one end of each of the acceleration units is revolved upon rotation of the carrier and the other end coupled to the cam groove such that the other end of each of the acceleration units is revolved along the cam groove, and each of which rotates a corresponding one of the hinge shafts such that each of the planetary gears is rotated, when a revolution angle at one end of each of the acceleration units is different from the revolution angle at the other end of each of the acceleration units, thereby accelerating rotation of the output shaft.

2. The driving body acceleration device according to claim 1, wherein the cam comprises a carrier location part formed at a center thereof to guide rotation of the carrier, a lower part of which is located in the carrier location part, the cam groove is formed at a circumference of the carrier location part in the shape of a closed loop such that one end of each of the acceleration units is located in the cam groove, and the cam groove is provided with a movement delay protrusion, which serves to delay the movement of a driving roller of each of the acceleration units when the driving roller of each of the acceleration units passes by the movement delay protrusion, such that the revolution of one end of each of the acceleration units at which the driving roller of each of the acceleration units is disposed is delayed by the movement delay protrusion while the other end of each of the acceleration units is continuously revolved upon rotation of the carrier, with the result that the planetary gears are rotated about the respective hinge shafts.

3. The driving body acceleration device according to claim 2, wherein the movement delay protrusion comprises a plurality of movement delay protrusions formed at the cam groove in a radial manner.

4. The driving body acceleration device according to claim 1, wherein each of the acceleration units comprises: a rod provided at one end thereof with a coupling part, which is coupled to a corresponding one of the hinge shafts such that the coupling part is revolved upon rotation of the carrier; a driving roller coupled to the other end of the rod, the driving roller being located in the cam groove such that the driving roller is moved along the cam groove upon revolution of the rod; and a roller shaft having one end coupled to the other end of the rod and the other end coupled to the driving roller.

5. The driving body acceleration device according to claim 1, wherein the acceleration units are mounted on the respective hinge shafts to which the planetary gears are coupled, the acceleration units being disposed around the output shaft in a radial manner.

6. The driving body acceleration device according to claim 4, further comprising a ratchet bearing coupled between an outer circumference of each of the hinge shafts and an inner circumference of the coupling part of each of the rods such that each of the hinge shafts is rotated upon rotation of each of the rods on a corresponding one of the hinge shafts and such that each of the rods is idled upon return of each of the rods to an original position thereof.
